(19) United States
(12) Patent Application Publication
(10) Pub. No.: US 2015/0059130 A1
(43) Pub. Date: Mar. 5, 2015

(54) ADJUSTABLE CORD HOLDING DEVICE

(71) Applicant: MING-TE HUNG, New Taipei City (TW)

(72) Inventor: MING-TE HUNG, New Taipei City (TW)

(21) Appl. No.: 14/016,642

(22) Filed: Sep. 3, 2013

(51) Int. Cl. F16G 11/10; F16G 11/04

(52) U.S. Cl. CPC F16G 11/106; F16G 11/04
USPC 24/122.3; 24/136 L

(57) ABSTRACT

A novel holding device for a cord is disclosed. The holding device includes a base and a cover. Both the cover and the base have openings to allow the cord to pass through the cover and the base. When the base and the cover are in contact, the fixation ring of the cover would press the fins of the base toward the cord. In this configuration, the holding device cannot move further in the direction toward the base due to the increased fixation force. The holding device can still move in the opposition direction without the increased fixation force.

### BACKGROUND

1. Field of the Invention

This invention relates generally to a cord holding device, and more specifically to an adjustable cord holding device that can be moved in one direction much easier than another direction.

2. Description of the Related Art

A cord holding device can be use to adjust the pulled-out length of a cord, string, belt, or rope. It is commonly used in clothing, accessories, sports, and safety equipment. For example, it can be used to adjust the length of the safety seatbelt to hold a passenger. It can also be used to adjust the tightness of the bag strap.

Most conventional cord holding devices, however, are bulky, and are not suitable for applications where the overall size is limited. There are some small cold holding devices available, but their simplified designs make the adjustment of the pulled-out length difficult. Accordingly, there is a need in the art for an adjustable cord holding device that is small, yet easy to use.

### SUMMARY

The present invention is directed to an adjustable cord holding device. The device comprises a cover and a base. When the cover is moved toward the base, the fixation ring of the cover may press the fins of the base further toward the cord. This would tighten the base to the cord, and would eventually stop the base's further movement in such direction.

According to another embodiment of the present invention, the cover and the base share a common housing, and a spring presses the base and the cover toward each other. At a first configuration, the adjustable cord holding device can only move in one direction. At a second configuration where the spring is compressed, the adjustable cord holding device can move in both directions along the cord.

This Summary is provided merely to introduce certain concepts and not to identify any key or essential features of the claimed subject matter.

### BRIEF DESCRIPTION OF THE DRAWINGS

These and other features, aspects, and advantages of the present invention will become better understood with regard to the following description, appended claims, and accompanying drawings where:

FIG. 1 shows a base for an adjustable cord holding device according to an embodiment of the present invention.

FIG. 2 shows a cover for an adjustable cord holding device according to an embodiment of the present invention.

FIG. 3 shows a configuration of an adjustable cord holding device according to an embodiment of the present invention.

FIG. 4 shows another configuration of an adjustable cord holding device according to another embodiment of the present invention.

FIGS. 5(a) and (b) show configurations of an adjustable cord holding device according to another embodiment of the present invention.

FIGS. 6(a) and (b) show configurations of an adjustable cord holding device according to another embodiment of the present invention.

### DETAILED DESCRIPTION

To be consistent throughout the descriptions and for clear understanding of the present invention, the following definitions are hereby provided for terms used therein:

The term “cord” refers to a linear collection of substances, which are combined together in a larger and stronger form. A cord is usually constructed of long and fibrous materials, and generally is constructed of certain natural or synthetic fibers. As used in the present invention, the scope of the term “cord” covers a string, a rope, a belt, a strap, a wire, a cable, a thread, a line, and others of similar nature. The cross section of the cord is usually round shape, but it can also be other shapes, such as a rounded rectangular shape and elliptical shape. For example, the cross section shape for the seatbelt is usually a rounded rectangle.

The term “comprises” are used herein to mean that other components, ingredients, steps, etc. are optionally present. For example, a device “comprising” components A and B can consist of components A and B, or can contain components A and B, and one or more other components.

Accordingly to an embodiment of the present invention, an adjustable cord holding device comprises a cover and a base. Both the cover and the base have holes to allow a cord to pass through them. When the base and the cover are placed approximate to each other, the combined structure may be moved in one direction more easily than the other direction.

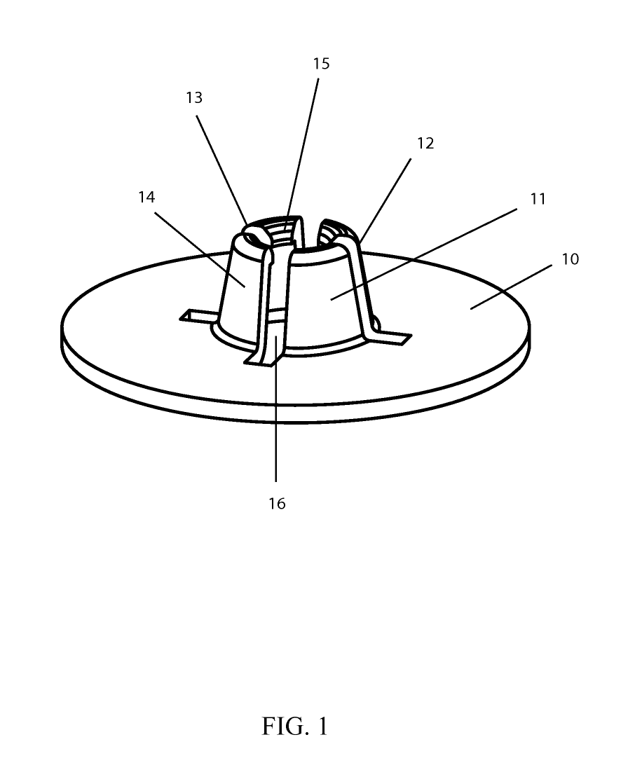

FIG. 1 shows a base 10 for an adjustable cord holding device according to an embodiment of the present invention. The base 10 may comprise a base hole 16 to allow a cord to pass through the base 10. The shape of the base hole 16 depends on the intended use of the adjustable cord holding device. If the cross section of the cord is round, the base hole 16 may also be round. On the other hand, when the intended cord is a belt, whose cross section is rounded rectangle, the base hole 16 may also be rounded rectangle.

The base 10 may comprise multiple fins to increase the base 10's fixation to a cord. In

FIG. 1, the base 10 comprises fins 11, 12, 13, and 14. The fins may incline toward the base hole 16. In a preferred embodiment of the present invention, the internal surfaces of the fins may be uneven to further increase the fixation of the fins to a cord. For example, the internal surface 15 of the fin 13 has linear uneven pattern to increase friction with the cord.

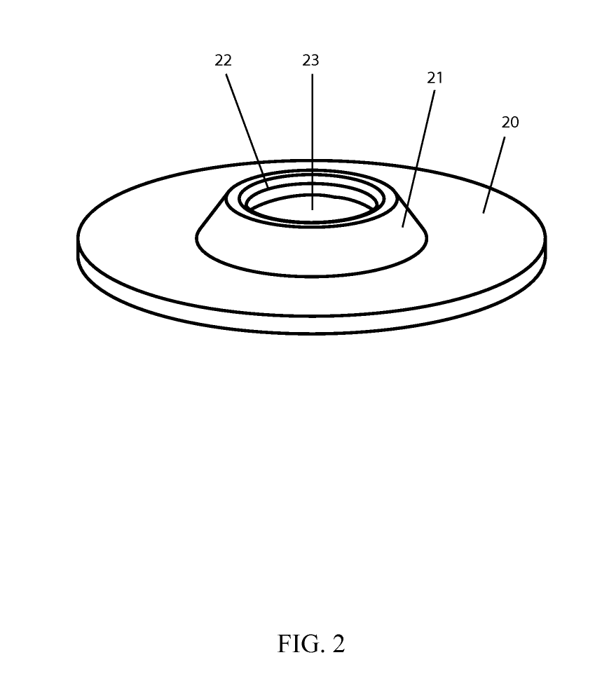

FIG. 2 shows a cover 20 for an adjustable cord holding device according to an embodiment of the present invention. As shown, the cover 20 may comprise a fixation ring 21 that surround the cover hole 23. In should be noted that the fixation ring 21 does not nave to be round. The cover hole 23 may allow a cord to pass through the cover 20. The fixation ring 21 may be used to tighten the fins of the base toward the cord. The internal surface 22 of the fixation ring 21 may also be uneven, thereby increasing its friction with other objects, such as the fins of the base or the cord. The shape of the fixation ring 21 may match the shape of the fins of the base.

Although the base 10 in FIG. 1 and cover 20 in FIG. 2 have rounded shapes, a person of ordinary skill in the art would recognize that the shapes of the cover 20 and base 10 are not material for the purpose of the present invention. For example, a shape of the cover 20 or base 10 may be a triangle, a rectangle, a polygon, an ellipse, an irregular shape, or a cartoon shape. Moreover, the shapes of the cover 20 and the base 10 do not have to be the same. For example, the cover 20 may have a circle shape and the base 10 may have a polygon shape.

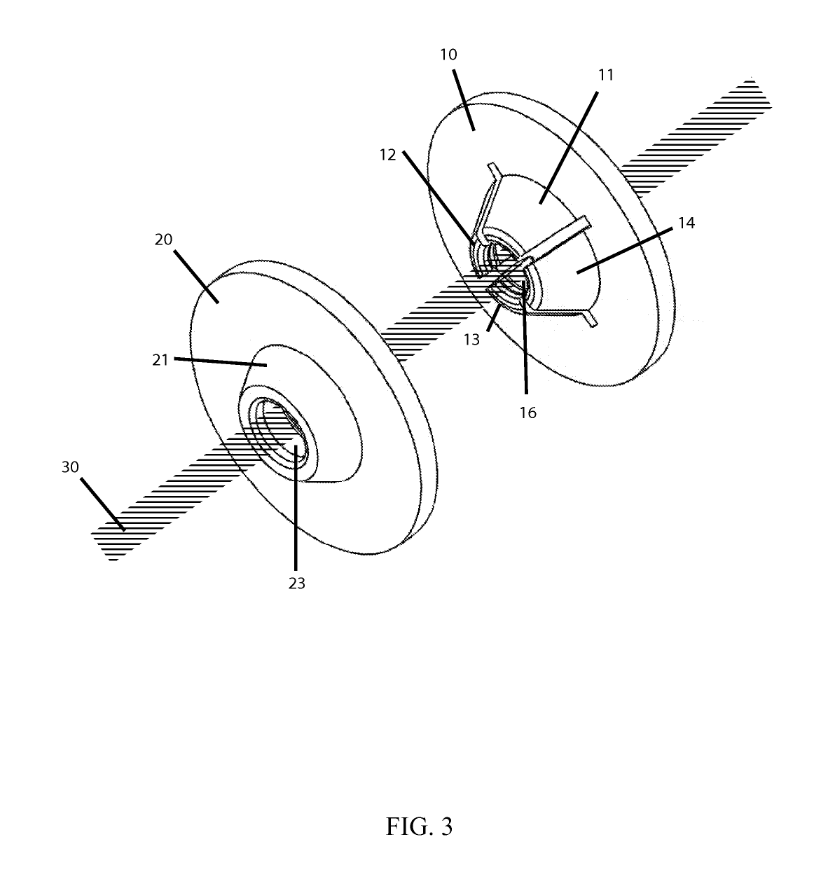

FIG. 3 shows a configuration of an adjustable cord holding device according to an embodiment of the present invention. The adjustable cord holding device may comprise a base 10 and a cover 20. The cover 20 may comprise a fixation ring 21. As previously described, the base 10 may comprise the fins 11, 12, 13, and 14. A person of ordinary skill in the art would recognize that the number of the fins, and the shapes of the fins are not material for the purpose of the present invention. For example, the base 10 may have 1 fin, or multiple fins.

The base 10 and the cover 20 may be aligned as shown in FIG. 3, such that a cord 30 may pass through the base hole 16 of the base 10 and the cover hole 23 of the cover 20. At this decoupled configuration, whereas the cover 20 is not in contact with the base 10, the base 10 and cover 20 may move freely along the cord 30 in either direction. For the cover 20, because the hole 23 is larger than the cross section of the cord 30, it can move along the cord 30 easily. For the base 10, because the fins 11, 12, 13, and 14 have not been forced toward the cord 30, the base 10 can also move along the cord 30.

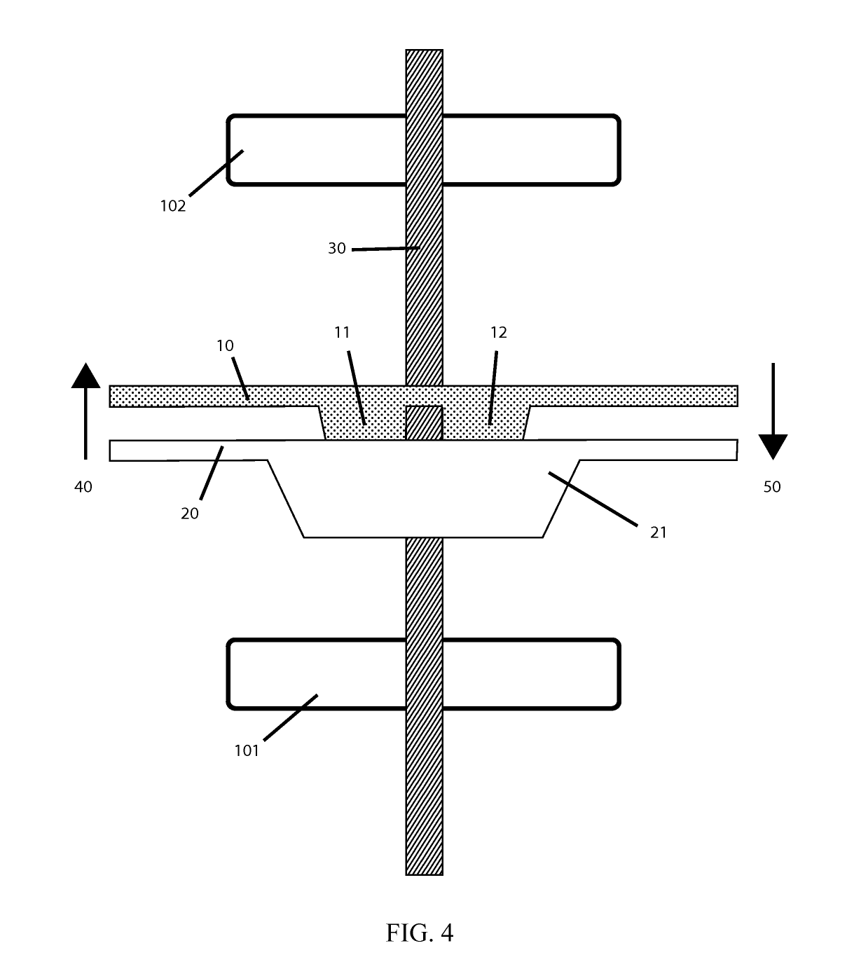

FIG. 4 shows another configuration of an adjustable cord holding device according to another embodiment of the present invention. In this configuration, the base 10 and the cover 20 are coupled together. As shown, when the cover 20 is coupled with the base 10, the fixation ring 21 of the cover 20 may force the fins of the base 10 toward the cord 30. For example, the fins 11 and 12 in FIG. 4 are now forced toward the cord 30 by the fixation ring 21. Hence, the more the cover 20 is moved in the direction 40, the more it is moved toward the base 10. This would push the base's fins tighter toward the cord, thereby increasing the force of fixation. Eventually, the increased force of friction would stop the cover 20's further movement in the direction 40. Therefore, at this configuration the feedback mechanism caused by the fixation ring 21 and the fins 11 and 12 would allow the combined structure to be able to move only toward direction 50.

When the object 101 is moved in the direction 40, it will eventually be in contact with the cover 20. Once it does, it will trigger the aforementioned feedback mechanism to stop further movement of the object 101 in the direction 40. In order for the object 101 to move further in the direction 40, the cover 20 must first be moved in the direction 50 to allow it to be decoupled with the base 10. Then, the base 10 can be moved in the direction 40, and the cover 20 may follow the movement, and eventually the object 101 can move further in the direction 40.

On the other hand, if the object 102 is to move in the direction 50, it will be in contact with the base 10. However, such movement will not trigger the feedback mechanism previously described, and therefore would allow the object 102, base 10, and cover 20 to move toward the direction 50.

In summary, once the base 10 and the cover 20 is coupled to each other, the movement of the cover 20 toward the base 10 would increase the fixation to the cord, thereby stopping any further movement in that direction. Thus, in this configuration, the cord-fixation force against moving the combined structure toward the direction 40 is greater than the cord-fixation force against moving the combined structure toward the direction 50.

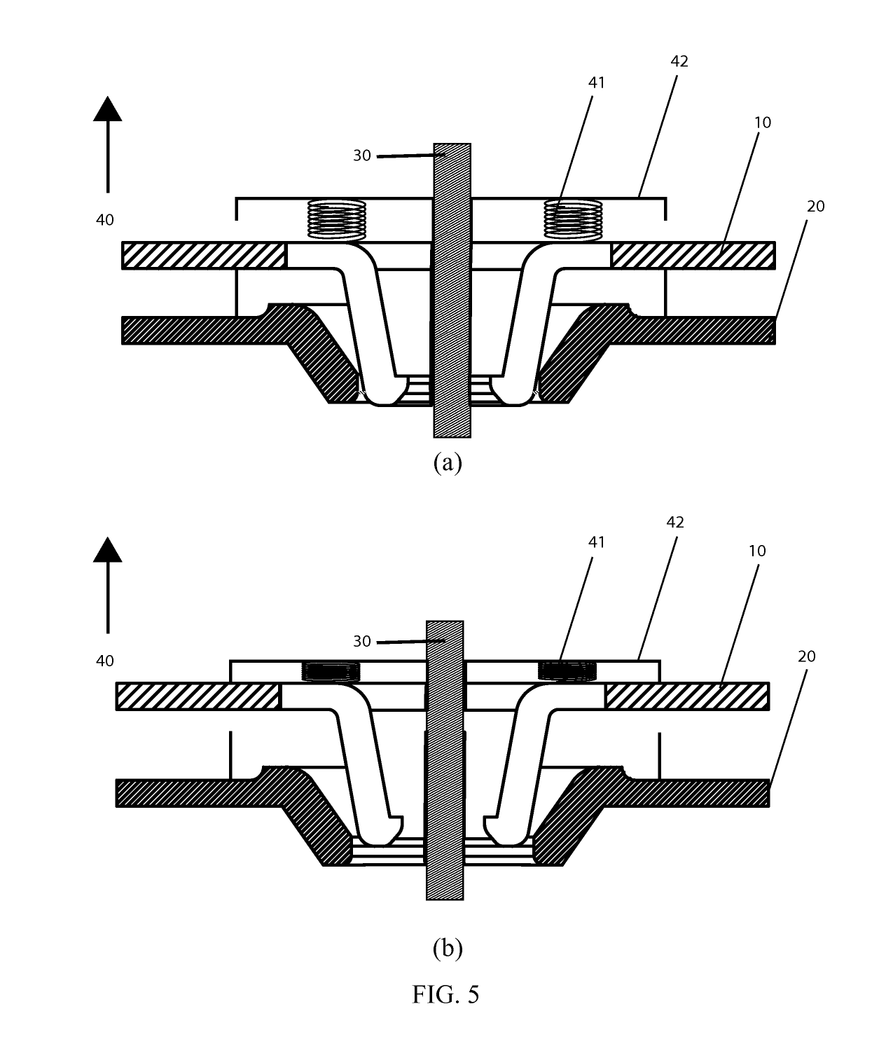

FIGS. 5(a) and (b) show configurations of an adjustable cord holding device according to another embodiment of the present invention. As shown in FIG. 5(a), the cover 20 and the base 10 share a common housing 42. One end of the spring 41 is attached to the common housing 42, and the other end of the spring 41 is attached to the base 10. Moreover, the spring 41 may push the base 10 and the cover 20 toward each other, into a coupled position as explained in the description section associated with FIG. 4. When the base 10 and the cover 20 are coupled to each other, as previously explained, the combined structure would stop further movement at the direction 40, because such movement would increase the fixation force between the base 10 and the cord 30. Hence, at this configuration, where the base 10 is forced to couple with the cover 20 by the string 41, the combined structure can only move in one direction along the cord 30, opposite of direction 40. A person of ordinary skill in the art would appreciate that the base 10 can also be coupled with the cover 20 by other means, such as a notch, magnetic force, suction force, and a bottom. For example, instead of using the spring 41 to force the base 10 and cover 20 at the coupled configuration, the base 10 and the cover 20 may be bottomed together.

In order to move in the direction 40, as illustrated in FIG. 5(b), the base 10 may be moved away from the cover 20 to compress the spring 41. This would decouple the base 10 from the cover 20, and the combined structure can now be moved in the direction 40. Hence, at this configuration, the combined structure can move in both directions along the cord 30. At previous example, where the base 10 and the cover 20 are bottomed together, a user may open the bottom(s) to decouple them.

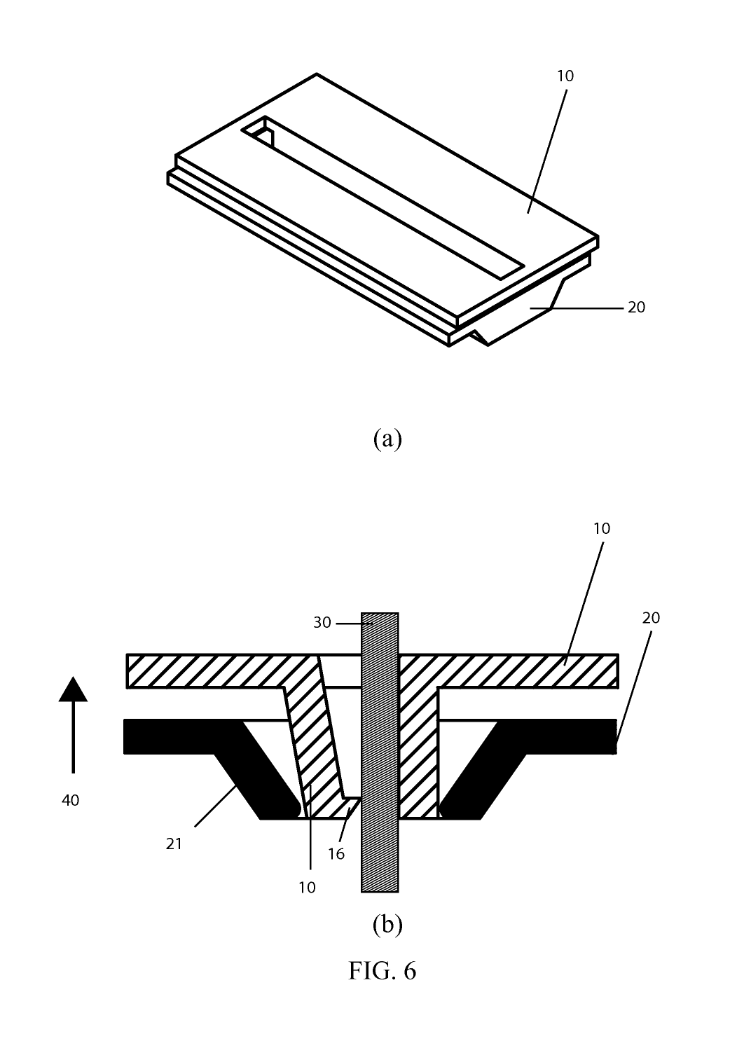

FIGS. 6(a) and (b) show configurations of an adjustable cord holding device according to another embodiment of the present invention. As previously mentioned, the cover 20 and base 10 may have shapes other than round shape. In FIG. 6(a), the cover 20 and the base 10 both have substantially rectangular shapes. The rectangular shapes may be chosen to adopt the slit opening adapted to fix on a belt. FIG. 6(b) shows a cross-sectional view of the adjustable cord holding device. As shown, as the cover 20 is moved toward base 10 in the direction 40, the fixation ring 21 of the cover 20 may press the fin 10 further toward the cord 30. If so, the notch 16 on the fin 10 may eventually fixed onto the cord 30 to stop further movement of the combined structure along the direction 40.

Although the present invention has been described in considerable detail with reference to certain preferred versions thereof, other versions are possible. Therefore, the spirit and scope of the appended claims should not be limited to the description of the preferred versions contained herein.

What is claimed is:

1. A holding device for a cord, comprising:
a base, comprising:
a base opening adapted to allow the cord to pass through the base; and
at least one fin, surrounding the base opening, adapted to fix the base onto the cord; and
a cover, comprising:
a fixation ring adapted to press the at least one fin toward the cord; and
a cover opening adapted to allow the cord to pass through the cover.

2. The holding device of claim 1, wherein, at a first configuration, a first cord-fixation force against moving the holding device toward a first direction is greater than a second cord-fixation force against moving the holding device toward a second direction.

3. The holding device of claim 2, wherein, at a second configuration, the first cord-fixation force against moving the holding device toward the first direction is about the same as the second cord-fixation force against moving the holding device toward the second direction.

4. The holding device of claim 3, wherein the first direction is pointed from the cover to the base, and the second direction is pointed from the base to the cover.

5. The holding device of claim 4, wherein the holding device is at the first configuration when the base and the cover are coupled together.

6. The holding device of claim 5, wherein the base and the cover are coupled together when the fixation ring is in contact with the at least one fin.

7. The holding device of claim 6, wherein the holding device is at the second configuration when the base and the cover are decoupled.

8. The holding device of claim 6, wherein the base and the cover are decoupled when the fixation ring is not in contact with the at least one fin.

9. The holding device of claim 8, wherein the at least one fin comprises a first fin and a second fin.

10. The holding device of claim 9, wherein an inner surface of the first fin is adapted to enhance fixation between the first fin and the cord.

11. The holding device of claim 10, wherein the inner surface of the first fin has linear uneven pattern.

12. The holding device of claim 9, wherein the first fin comprises a notch at an inner surface of the first fin.

13. The holding device of claim 10, further comprising a housing adapted to enclose the cover and the base.

14. The holding device of claim 13, further comprising a spring unit adapted to force the base and the cover at the first configuration.

15. The holding device of claim 14, wherein a first end of the spring unit is attached to the housing and a second end of the spring unit is attached to the base unit.

16. The holding device of claim 15, wherein a user can manually compress the spring unit to subject the holding device to the second configuration.

17. The holding device of claim 9, wherein the cord is a linear collection of substances combined together in a larger and stronger form.

18. The holding device of claim 17, wherein the cord is a string, a rope, a belt, a strap, a wire, a cable, a thread, or a line.

19. The holding device of claim 12, wherein the base opening is a slit and the cord is a belt.

20. The holding device of claim 9, wherein the first fin inclines toward the base hole.
